(19) United States
(12) Patent Application Publication
(10) Pub. No.: US 2013/0259747 A1
(43) Pub. Date: Oct. 3, 2013

(54) Optical Biosensor

(71) Applicant: SAMSUNG ELECTRONICS CO., LTD., SUWON-SI (KR)

(72) Inventors: Beom Suk Lee, Yongin-si (KR); Kyoung-Won Na, Seoul (KR); Yoon-Dong Park, Osan-si (KR); Sung-Dong Suh, Seoul (KR); Dong-Mo Im, Jindo-gun (KR)

(73) Assignee: SAMSUNG ELECTRONICS CO., LTD., Suwon-si (KR)

(21) Appl. No.: 13/754,347

(22) Filed: Jan. 30, 2013

(30) Foreign Application Priority Data
Mar. 27, 2012 (KR) 10-2012-0031216

(51) Int. Cl. G01N 21/84

(52) U.S. Cl. CPC G01N 21/84
USPC 422/69; 250/216; 250/227.11

(57) ABSTRACT

An optical biosensor includes a sensing block that receives a first optical signal and outputs a second optical signal through at least one channel of a plurality of channels that correspond to a sensed concentration of a biomaterial; and a detecting block that detects the second optical signal, converts the second optical signal into an electrical signal, and outputs the electrical signal.

### CROSS-REFERENCE TO RELATED APPLICATIONS

This application claims the benefit of Korean Patent Application No. 10-2012-0031216, filed on Mar. 27, 2012, in the Korean Intellectual Property Office, the contents of which are herein incorporated by reference in their entirety.

### BACKGROUND

Embodiments of the inventive concept relate to a biosensor, and more particularly, to an integrated optical biosensor based on silicon photonics technology.

Biosensors are devices for measuring a concentration of an organic material or an inorganic material in a liquid or gaseous state. Examples of a biosensor include piezoelectric biosensors, optical biosensors, electrochemical biosensors, etc. An optical biosensor measures a concentration of a biomaterial by interaction between a biological element and a material to be detected. A bio-sensing system including an optical biosensor includes a power source, a biosensor chip, and a spectrometer. Light emitted from a power source is incident on a biosensor chip via a grating coupler, and the light having passed through the biosensor chip is incident on a spectrometer via the grating coupler which analyzes wavelengths of the light to measure a concentration of a biomaterial sensed by the biosensor chip.

### SUMMARY

Embodiments of the inventive concept provide an optical biosensor adapted for miniaturization, low power consumption, and portability by integrating on one chip those components used for optical biosensing based on photonics technology.

According to an aspect of the inventive concept, there is provided an optical biosensor including: a sensing block that receives a first optical signal and outputs through at least one channel of a plurality of channels a second optical signal that correspond to a sensed concentration of a biomaterial; and a detecting block that detects the second optical signal, converts the second optical signal into an electrical signal, and outputs the electrical signal.

The optical biosensor may further include a light source that provides the first optical signal to the sensing block, and a semiconductor substrate upon which the light source, the sensing block and the detecting block are disposed.

The detecting block may include a plurality of photodetectors, each photodetector corresponding to one of the plurality of channels, wherein each photodetector converts the second optical signal received from the corresponding channel into the electrical signal.

The sensing block may include: a sensor that extracts from wavelength components of the first optical signal a resonant wavelength that corresponds to the sensed concentration of the biomaterial to generate a sensing optical signal; and a wavelength demultiplexer that divides the sensing optical signal by wavelengths and outputs the divided sensing optical signal as the second optical signal.

The sensor may include: a first optical waveguide that receives the first optical signal from the light source; a ring resonator separated from the first optical waveguide by a predetermined interval that extracts the resonant wavelength from the wavelengths of the first optical signal; and a second optical waveguide separated from the first optical waveguide by a predetermined interval that receives the resonant wavelength from the ring resonator to transmit the resonant wavelength as the sensing optical signal.

The sensor may include: a first optical waveguide that receives the first optical signal from the light source; a cavity resonator connected to the first optical waveguide that outputs a resonant wavelength removed from the wavelengths of the first optical signal as the sensing optical signal; and a second optical waveguide connected to the cavity resonator that receives the sensing optical signal and transmits the sensing optical signal to the wavelength demultiplexer.

The wavelength demultiplexer may include an arrayed waveguide grating.

The sensing block may include: a first optical waveguide that receives the first optical signal and outputs the sensing optical signal generated by removing from the first optical signal a resonant wavelength that corresponds to the sensed concentration of the biomaterial; and a ring resonator separated from the first optical waveguide by a predetermined interval that removes the resonant wavelength from wavelengths of the first optical signal; and a wavelength demultiplexer that divides the sensing optical signal by wavelengths and outputs the divided sensing optical signal as the second optical signal.

The sensing block may include: a first optical waveguide that receives the first optical signal; a plurality of ring resonators, each ring resonator being separated from the first optical waveguide by a predetermined interval and having a different resonant wavelength that varies according to a concentration of the biomaterial, wherein one of the plurality of ring resonators receives the first optical signal from the first optical waveguide when the resonant wavelength is the same as a wavelength of the first optical signal; and a plurality of second optical waveguides respectively corresponding to the plurality of ring resonators, wherein each second optical waveguide is separated from the corresponding ring resonator by a predetermined interval.

A ring resonator receiving the first optical signal of a resonant wavelength from the first optical waveguide removes the resonant wavelength from the first optical signal and outputs the resonant wavelength as the second optical signal through the corresponding second optical waveguide.

The biomaterial may include DNA or protein.

The optical biosensor may further include a signal processing unit that determines a concentration of the biomaterial based on the electrical signal received from the detecting block.

According to another aspect of the inventive concept, there is provided a bio-sensing system including: a fluidic channel through which a biomaterial flows; and a biosensor chip having an opening that contacts the fluidic channel and that senses a concentration of the biomaterial flowing through the fluidic channel based on an optical characteristic and outputs the concentration of the biomaterial as an electrical signal, wherein the biosensor chip has integrated onto one substrate a sensing block that senses a concentration of a biomaterial to output the concentration of the biomaterial as an optical signal, and a detecting block that converts the optical signal output from the sensing block into an electrical signal.

The bio-sensing system may further include a light source that provides light to the sensing block, and a signal processing unit that determines the concentration of the biomaterial by analyzing the electrical signal.

According to another aspect of the inventive concept, there is provided a bio-sensing system including: a sensing block comprising one or more optical resonators, each of the one or more optical resonators adapted to removing a different resonant optical wavelength from a first optical signal comprising a plurality of wavelengths to generate a sensing optical signal, wherein said optical resonators are adapted for receiving and coupling to a biomaterial that changes the resonant optical wavelength of the resonator; and a plurality of output channels, each output channel corresponding to a different resonant optical wavelength that corresponds to a sensed concentration of a biomaterial.

The optical biosensor may further include one optical resonator; a first waveguide that receives the first optical signal from a light source and provides the first optical signal to the one optical resonator, wherein the sensing optical signal generated by the optical resonator comprises the resonant optical wavelength removed from the first optical signal; a second waveguide that receives the sensing optical signal from the one optical resonator; and a wavelength demultiplexer that receives the sensing optical signal from the second waveguide, divides the sensing optical signal by wavelengths, and outputs the divided sensing optical signal as a second optical signal to each of the plurality of channels.

The optical resonator may be one of a ring resonator or a cavity resonator.

The optical biosensor may further include one optical resonator; a first waveguide separated from the one optical resonator by a predetermined distance that receives the first optical signal from a light source, wherein the sensing optical signal generated from the first optical signal by the one optical resonator does not include a wavelength component corresponding to the resonant optical wavelength; and a wavelength demultiplexer that receives the sensing optical signal from the first waveguide, divides the sensing optical signal by wavelengths and outputs the divided sensing optical signal as a second optical signal to each of the plurality of channels.

The optical biosensor may further include a plurality of optical resonators; a first waveguide separated from each of the plurality of optical resonators by a predetermined distance that receives the first optical signal from a light source, wherein one of the plurality of optical resonators receives the first optical signal from the first optical waveguide when the resonant wavelength is the same as a wavelength of the first optical signal, removes the resonant wavelength from the first optical signal and outputs the resonant wavelength as a second optical signal; and a plurality of second optical waveguides that respectively correspond to the plurality of optical resonators, wherein each second optical waveguide receives the second optical signal from the corresponding optical resonator and outputs the second optical signal to a corresponding channel of the plurality of channels.

The optical biosensor may further include a detecting block including a plurality of photodetectors, each photodetector connected to one of the plurality of output channels, wherein each photodetector is adapted to detecting an optical signal received through the corresponding output channel, converting the optical signal into an electrical signal, and outputting the electrical signal.

### BRIEF DESCRIPTION OF THE DRAWINGS

FIG. 1 is a block diagram of an optical biosensor according to an embodiment of the inventive concept.

FIG. 2A is a view showing an example of an optical waveguide.

FIG. 2B is a view showing an example of a silicon waveguide formed on a semiconductor substrate.

FIG. 3 is a circuit diagram showing an example of the optical biosensor 100 of FIG. 1.

FIGS. 4A to 4C are views that illustrate a structure of a sensor of FIG. 3.

FIGS. 5A to 5C are views that illustrate a variation in a resonant wavelength according to a concentration of a biomaterial in the optical biosensor of FIG. 3.

FIG. 6 is a view showing wavelengths of optical signals according to an operation of a sensor unit of the optical biosensor of FIG. 3.

FIG. 7 is a circuit diagram showing an optical biosensor according to another embodiment of the inventive concept.

FIG. 8 is a circuit diagram showing an optical biosensor according to another embodiment of the inventive concept.

FIG. 9 is a view showing wavelengths of optical signals according to operations of a sensor unit of the optical biosensor of FIG. 8.

FIG. 10 is a circuit diagram showing an optical biosensor according to another embodiment of the inventive concept.

FIG. 11 is a block diagram showing an optical biosensor according to another embodiment of the inventive concept.

FIG. 12 is a block diagram showing an example of a signal processing unit of FIG. 11.

FIG. 13 is a view of a bio-sensing system according to another embodiment of the inventive concept.

### DETAILED DESCRIPTION OF EXEMPLARY EMBODIMENTS

Embodiments of the inventive concept will now be described more fully with reference to the accompanying drawings, in which exemplary embodiments of the inventive concept are shown. Embodiments of the inventive concept may, however, take many different forms by one of ordinary skill in the art without departing from the technical teaching of the inventive concept. Also, throughout the specification, like reference numerals in the drawings may denote like elements. In the drawings, the sizes of structures may be exaggerated or reduced for clarity of the specification.

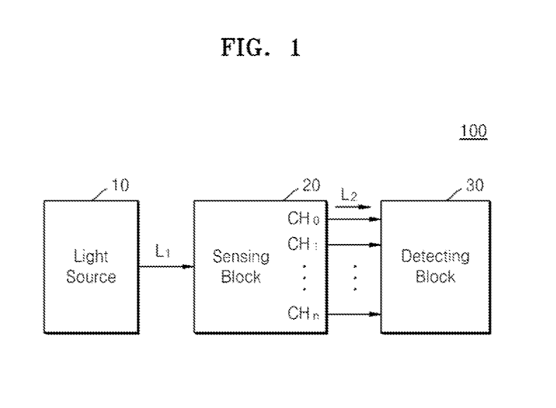

FIG. 1 is a block diagram of an optical biosensor 100 according to an embodiment of the inventive concept.

Referring to FIG. 1, the optical biosensor 100 includes a light source 10, a sensing block 20, and a detecting block 30. The sensing block 20 and the detecting block 30 may be formed on a semiconductor substrate. The light source 10 may be formed on the semiconductor substrate on which the sensing block 20 and the detecting block 30 are formed or may be packaged on the semiconductor substrate.

The light source 10 transmits a first optical signal L1 to the sensing block 20.

The sensing block 20 receives the first optical signal L1 to sense a concentration of a biomaterial and outputs a second optical signal L2 through at least one of a plurality of channels that correspond to the sensed biomaterial.

The detecting block 30 detects the second optical signal L2 output from the at least one channel from the sensing block 20, converts the second optical signal L2 into an electrical signal, and outputs the electrical signal.

A conventional optical bio-sensing system determines a concentration of a biomaterial by analyzing a wavelength of an optical signal that has sensed the concentration of the biomaterial, and thus, an apparatus such as a spectrometer for analyzing a wavelength of an optical signal is necessary. In addition, an arrangement operation that connects the optical biosensor to the spectrometer is necessary, thereby increasing a system complexity and cost. However, the optical biosensor 100 of a current embodiment senses a concentration of a biomaterial using optical characteristics, and converts a sensing result into an electrical signal. Thus, the optical biosensor 100 may determine the concentration of a biomaterial by analyzing a variation of an electrical signal. Accordingly, a large apparatus, such as a spectrometer, and an arrangement operation that connects a biosensor and a spectrometer are unnecessary, and thus, the optical biosensor 100 of a current embodiment is adapted to portability, miniaturization, and low power consumption.

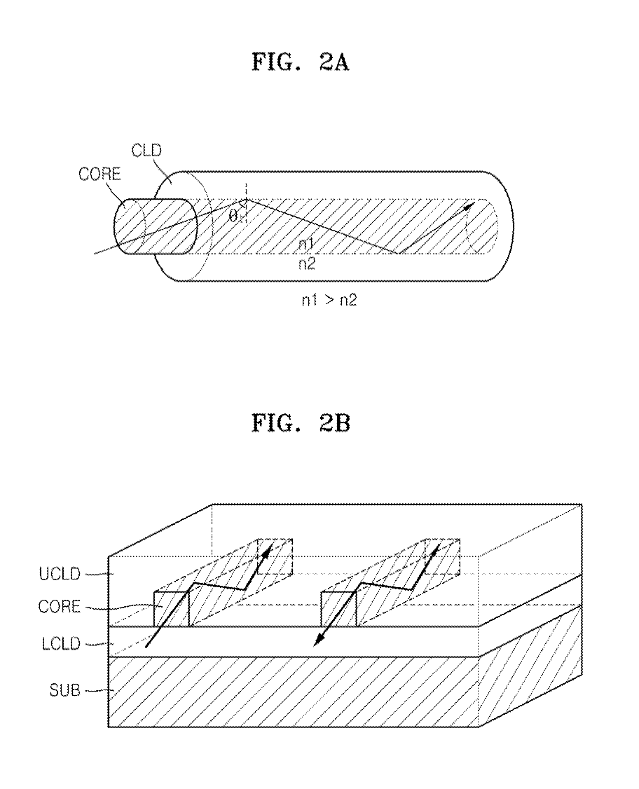

The optical biosensor 100 of FIG. 1 is formed on a semiconductor substrate based on silicon photonics technology. Specifically, the sensing block 20 may include an optical waveguide for transmitting optical signals L1 and L2, wherein the optical waveguide may be a waveguide formed on the semiconductor substrate. Hereinafter, a waveguide formed on the semiconductor substrate will be described in detail with reference to FIGS. 2A and 2B.

FIG. 2A is a view showing an example of an optical waveguide, and FIG. 2B is a view showing an example of a silicon waveguide formed on a semiconductor substrate. Referring to FIG. 2A, the optical waveguide includes a core CORE through which an optical signal is transmitted, and a cladding CLD surrounding the core CORE. A refractive index n1 of the core CORE is higher than a refractive index n2 of the cladding CLD. Thus, if an optical signal is incident on the core CORE at an angle θₜ greater than a threshold value, the optical signal may propagate along the core CORE by total internal reflection without radiating to the outside.

FIG. 2B is a view of a silicon waveguide formed on a semiconductor substrate SUB. Referring to FIG. 2B, a lower cladding layer LCLD may be formed on the semiconductor substrate SUB, a core layer CORE may be formed on the lower cladding layer LCLD, and then an upper cladding layer UCLD may be formed to surround the core layer CORE. However, this is just an example, and if the upper cladding layer UCLD is formed to surround the core layer CORE, layer shape and an order of layer formation may vary.

The core layer CORE may be formed of silicon (Si), and the lower and upper cladding layers LCLD and UCLD may be formed of an oxide (Ox). Since refractive indexes of Si and an Ox are about 3.5 and about 1.4, respectively, the refractive index of the core layer CORE is higher than those of the upper and lower cladding layers UCLD and LCLD. Thus, when an optical signal is incident on the core layer CORE and an incident angle is greater than a threshold value, total internal reflection occurs at a boundary between the core layer CORE and the upper and lower cladding layers UCLD and LCLD, and thus, an optical signal may be transmitted along the core layer CORE.

Alternatively, when the upper cladding layer UCLD is a passivation layer, the upper cladding layer UCLD may be formed of silicon nitride (SiN), a polyimide (PI), etc. Since refractive indexes of SiN and a PI are about 2.0 and about 1.7, respectively, the refractive index of the upper cladding layer UCLD is lower than that of the core layer CORE, and thus, the upper cladding layer UCLD meets the conditions of a waveguide.

However, the above-described materials are non-limiting examples of materials used for forming an optical waveguide on a semiconductor substrate, and the inventive concept is not limited thereto. An optical waveguide may be formed of any of various materials having different refractive indexes, and materials for forming the core layer CORE and the upper and lower cladding layers UCLD and LCLD may be selectively manufactured according to characteristics of a desired optical waveguide.

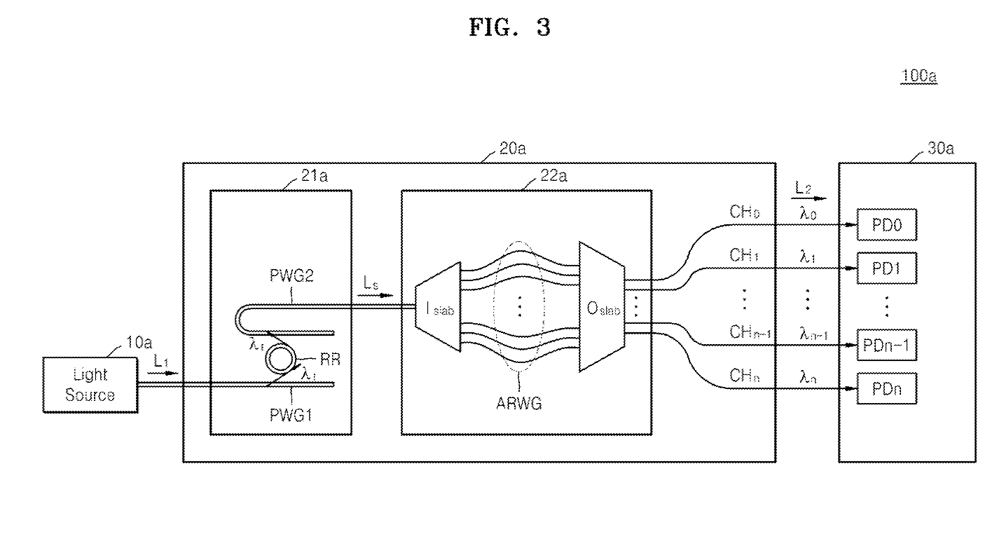

FIG. 3 is a circuit diagram showing an example of the optical biosensor 100 of FIG. 1.

Referring to FIG. 3, an optical biosensor 100a includes a light source 10a, a sensing block 20a, and a detecting block 30a.

The light source 10a generates a first optical signal L1 that includes wavelength components in a predetermined range. The first optical signal L1 may include wavelength components in the range of tens of nm. For example, the light source 10a may be an amplified spontaneous emission (ASE) or a superluminiscent light-emitting diode (SLED).

The sensing block 20a receives the first optical signal L1 from the light source 10a, generates a second optical signal L2 in which wavelength components vary according to a concentration of a sensed biomaterial, and outputs the second optical signal L2. Here, the second optical signal L2 is divided into wavelengths to be transmitted through at least one corresponding channel from among a plurality of channels CH0 to CHn.

The sensing block 20a may include a sensor 21a and a wavelength demultiplexer 22a. The sensor 21 receives the first optical signal L1, generates a sensing optical signal Ls in correspondence to the concentration of the biomaterial, and transmits the sensing optical signal Ls. Here, the sensing optical signal Ls may lack a specific wavelength range removed from the first optical signal L1 or have a specific wavelength range extracted from the first optical signal L1.

The wavelength demultiplexer 22a divides the sensing optical signal Ls according to wavelengths to generate the second optical signal L2 and outputs the second optical signal L2 through at least one channel of the channels CH0 to CHn that corresponds to a wavelength of the second optical signal L2. For example, if the wavelength of the second optical signal L2 is λ₂, the second optical signal L2 may be output through a channel 2 CH2 of the channels CH0 to CHn corresponding to the wavelength λ₂. Alternatively, if the second optical signal L2 is an optical signal including a plurality of wavelengths, for example, λ₀, λ₂, and λ₃, the second optical signal L2 may be output through a channel 0 CH0, the channel 2 CH2, and channel 3 CH3. As such, the second optical signal L2 may be output through at least one channel of the channels CH0 to CHn.

The detecting block 30a detects each of the optical signals λ₀ to λₙ that are received through the at least one channel of the channels CH0 to CHn as an electrical signal. The detecting block 30a may include a plurality of photodetectors PD0 to PDn corresponding to the channels CH0 to CHn. The photodetectors PD0 to PDn convert the optical signals received through the respective channels into electrical signals according to a number of photons.

For example, when an optical signal of wavelength λ₁ is transmitted through channel 1 CH 1, the photodetector 1 PD 1 converts the optical signal of wavelength λ₁ into an electrical signal according to a number of photons. Since there is no optical signal applied to the other photodetectors PD0 and PD2 to PDn, little or no electrical signal may be output therefrom.

Alternatively, when optical signals of wavelengths λ₂ to λ₅ are respectively transmitted through channel2 to channel 5 CH2 to CH5, photodetector 2 PD2 to photodetector 5 PD5 convert the respective wavelength signals into electrical signals and output the electrical signals. The other photodetectors PD0, PD1, and PD6 to PDn may output extremely weak electrical signals if at all.

Since the photodetectors corresponding to the wavelengths λ₀ to λn of the second optical signal L2 received from the sensing block 20 convert the optical signals into electrical signals and output the electrical signals, a concentration of a biomaterial may be determined by analyzing which photodetectors have generated an electrical signal.

Hereinafter, the sensor 21a and the wavelength demultiplexer 22a will be described with reference to FIG. 3.

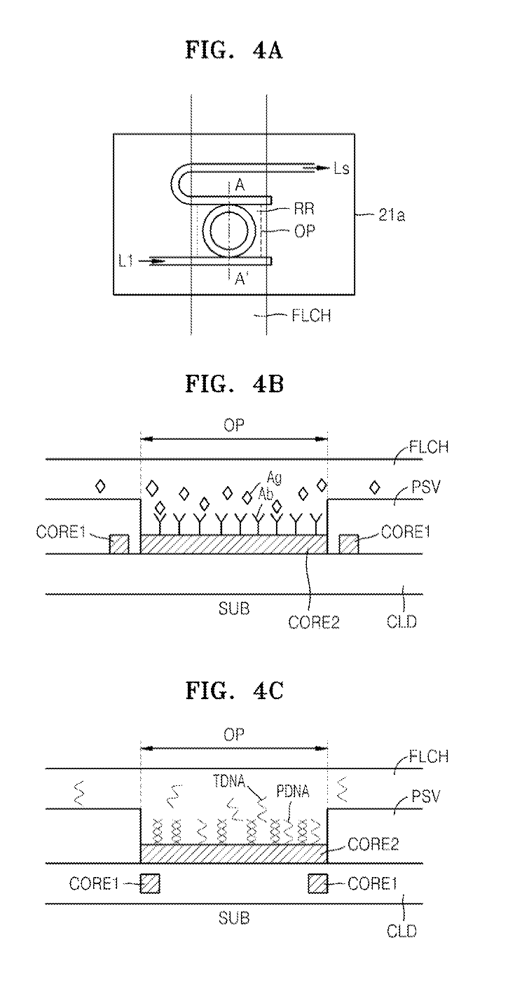

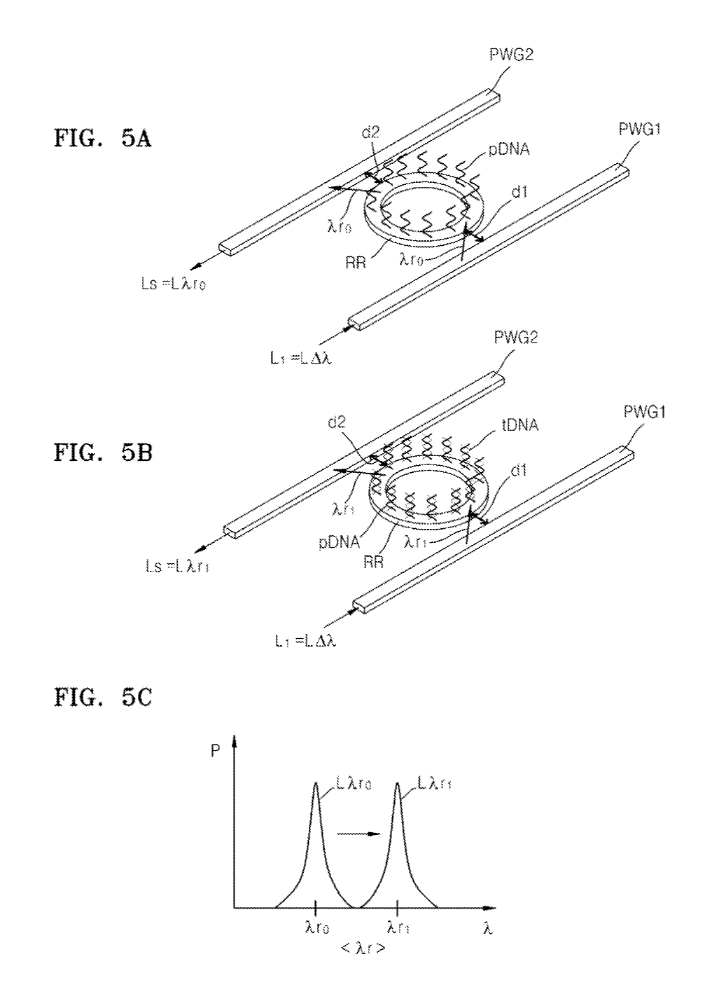

The sensor 21a may include a first optical waveguide PWG1, a ring resonator RR, and a second optical waveguide PWG2. The first optical waveguide PWG1, the ring resonator RR, and the second optical waveguide PWG2 may each be an optical waveguide formed on the semiconductor substrate, as described with reference to FIG. 2B. The first optical waveguide PWG1 and the second optical waveguide PWG2 may be linear optical waveguides, and the ring resonator RR may be a circular optical waveguide or a superelliptical-shaped optical waveguide. The first optical waveguide PWG1, the ring resonator RR, and the second optical waveguide PWG2 are separated by predetermined intervals. From wavelengths of the first optical signal L1 that are received from the light source 10a and propagate through the first optical waveguide PWG1 by total internal reflection, a wavelength that meets the conditions of the ring resonator RR waveguide, that is, a resonant wavelength λᵣ, is transmitted to the ring resonator RR. Then, the resonant wavelength λᵣ is transmitted through the ring resonator RR to the second optical waveguide PWG2 to be output as the sensing optical signal Ls. Thus, the sensing optical signal Ls that is generated by and output from the sensor 21a is an optical signal corresponding to the resonant wavelength λᵣ extracted from the first optical signal L1. Here, the resonant wavelength may vary according to a concentration of the biomaterial sensed by the sensor 21a. Accordingly, wavelength components of the sensing optical signal Ls may vary, as will be described in detail with reference to FIGS. 4A to 5C.

As shown in FIG. 3, the wavelength demultiplexer 22a may be an arrayed waveguide grating. The arrayed waveguide grating is a type of filter that can divide an optical signal of different wavelengths according to the wavelengths. However, this is exemplary and non-limiting, and the wavelength demultiplexer 22a is not limited to an arrayed waveguide grating. Any circuit, semiconductor device, etc., that can divide a signal according to a wavelength may be also used as the wavelength demultiplexer 22a.

The wavelength demultiplexer 22a includes input and output slab waveguides I_{slab} and O_{slab}, which are free transmission areas, and arrayed waveguides ARWG that connect the input and output slab waveguides I_{slab} and O_{slab}. The input and output slab waveguides I_{slab} and O_{slab} and the arrayed waveguides ARWG function as lens and gratings, respectively. There is a predetermined channel difference between any two adjacent waveguides of the arrayed waveguides ARWG. The incident sensing optical signal Ls is dispersed in the input slab waveguide I_{slab} and is transmitted to the arrayed waveguides ARWG. Signals transmitted through the arrayed waveguides ARWG having a predetermined channel difference between adjacent waveguides cause constructive interference in the output slab waveguide O_{slab} and are focused at different locations according to wavelengths. Output waveguides, that is, channels CH0 to CHn, are respectively connected to focus locations according to wavelengths. Accordingly, optical signals having different wavelengths are output in correspondence with the channels CH0 to CHn.

The sensing optical signal Ls incident on the wavelength demultiplexer 22a is divided into wavelengths λ₀ to λₙ, and is output as the second optical signal L2. The sensing optical signal Ls may be output according to wavelengths through channels corresponding to the channels CH0 to CHn. Here, as described above, since the sensing optical signal Ls is an optical signal having a specific resonant wavelength λᵣ, the second optical signal L2 is an optical signal having the resonant wavelength λᵣ. Accordingly, the second optical signal L2 may be output via a channel of the channels CH0 to CHn corresponding to the resonant wavelength λᵣ.

As described above, an optical biosensor according to a current embodiment divides the sensing optical signal Ls generated by the sensing block 20a according to wavelengths to output the divided sensing optical signal Ls as the second optical signal L2, and the detecting block 30a detects the wavelengths λ₀ to λn of the second optical signal L2 to output the wavelengths λ₀ to λₙ as electrical signals. Thus, a concentration of a biomaterial may be quantitatively analyzed by analyzing variations in an electrical signal without using an apparatus, such as a spectroscope, for analyzing a wavelength of an optical signal.

Hereinafter, a structure and operations of the sensor 21a will be described in detail with reference to FIGS. 4A to 5C.

FIGS. 4A to 4C are views that illustrate a structure of the sensor 21a of FIG. 3. FIGS. 5A to 5C are views that illustrate a variation in a resonant wavelength according to a concentration of a biomaterial in the sensor 21a of FIG. 3.

Referring to FIG. 4A, an opening OP for contacting an external material, for example, a biomaterial to be sensed, is formed in a top portion of the ring resonator RR of the sensor 21a. After a semiconductor device, a circuit, etc., is formed on a semiconductor substrate, a passivation layer PSV for protecting the semiconductor device from the external material may be formed, and the opening OP may be formed by not coating the passivation material on the ring resonator RR. A fluid or gas including a biomaterial may flow into the sensor 21a through a fluidic channel (FLCH) that is located outside the sensor 21a and may contact the ring resonator RR via the opening OP.

FIGS. 4B and 4C are cross-sectional views taken along line A-A′ of FIG. 4A. Referring to FIGS. 4B and 4C, a core CORE1 of a linear waveguide and a core CORE2 of a ring resonator may formed in parallel from the same layer, as shown in FIG. 4B. Alternatively, the core CORE1 and the core CORE2 may be formed from different layers, as shown in FIG. 4C. A passivation material PSV is not coated on the core CORE2 of the ring resonator, thus forming the opening OP.

A receptor for a biomaterial to be measured is fixed to a surface of the core CORE2 of the ring resonator. The receptor may be fixed to the surface of the core CORE2 of the ring resonator by using a biological or physicochemical method. A concentration of the receptor may vary according to a biomaterial to be detected. For example, the receptor may be protein antigen Ab or probe DNA (pDNA). If a biomaterial (Ag or tDNA) couples to the receptor (Ab or pDNA), an effective refractive index of the core CORE2 of the ring resonator is changed. A resonant wavelength λᵣ of the ring resonator may vary according to the effective refractive index of the core CORE2. An equation of the resonant wavelength λᵣ is as follows.

λᵣ=n_{eff}2πR/m (1)

Here, n_{eff} denotes an effective refractive index, R denotes a radius of the ring resonator, and m denotes an integer. Referring to EQ. (1), a resonant wavelength is proportional to the effective refractive index. Thus, if the effective refractive index increases or decreases, the resonant wavelength λr of the ring resonator increases or decreases, accordingly. For example, before the receptor (Ag or pDNA) couples to the biomaterial (Ab or tDNA), the effective refractive index of the ring resonator is nₒ. When the resonant wavelength λᵣ is λ₀, if the biomaterial has coupled to the receptor, the effective refractive index of the ring resonator may increase in the order of n₁, n₂, n₃, etc., and the resonant wavelength λᵣ may have values of λ₁, λ₂, λ₃, etc. A coupling strength between the receptor (Ag or pDNA) and the biomaterial (Ab or tDNA) varies according to a concentration of the biomaterial (Ab or tDNA), and thus, the resonant wavelength λᵣ may vary according to the concentration of the biomaterial.

Next, operations of the sensor 21a of FIG. 2 will be described with reference to FIGS. 5A to 5C. An exemplary, non-limiting case of measuring a concentration of DNA in a biomaterial will be described. FIG. 5A illustrates the sensor 21a before pDNA couples to target DNA (tDNA), and FIG. 5B illustrates the sensor after the pDNA couples to the target tDNA. FIG. 5C is a graph showing wavelengths of an output optical signal L2 of FIGS. 5A and 5B.

Referring to FIGS. 5A and 5B, if a first optical signal L1 having a wavelength Δλ with a predetermined bandwidth is incident on a first optical waveguide PWG1, the first optical signal L1 propagates along the first optical waveguide PWG1. Here, a resonant wavelength λᵣ of the wavelength Δλ with a predetermined bandwidth propagates to a ring resonator RR through a gap d1 between the first optical waveguide PWG1 and the ring resonator RR. The resonant wavelength λᵣ propagates to the second waveguide PWG2 through a gap d2 between the ring resonator and the second waveguide PWG2 to be output as a sensing optical signal Ls.

As shown in FIG. 5A, when the pDNA are not coupled to the tDNA, the resonant wavelength λᵣ is λr₀. Here, as described above, a refractive index of the ring resonator RR varies according to the coupling strength of the pDNA to the tDNA, and thus, the resonant wavelength λᵣ varies. Accordingly, as shown in FIG. 5B, if the pDNA couples to the tDNA, the resonant wavelength λᵣ changes to λr₁. Therefore, as shown in FIG. 5C, the wavelength λᵣ of the sensing optical signal Ls changed from λr₀ (before coupling) to λr₁ (after coupling).

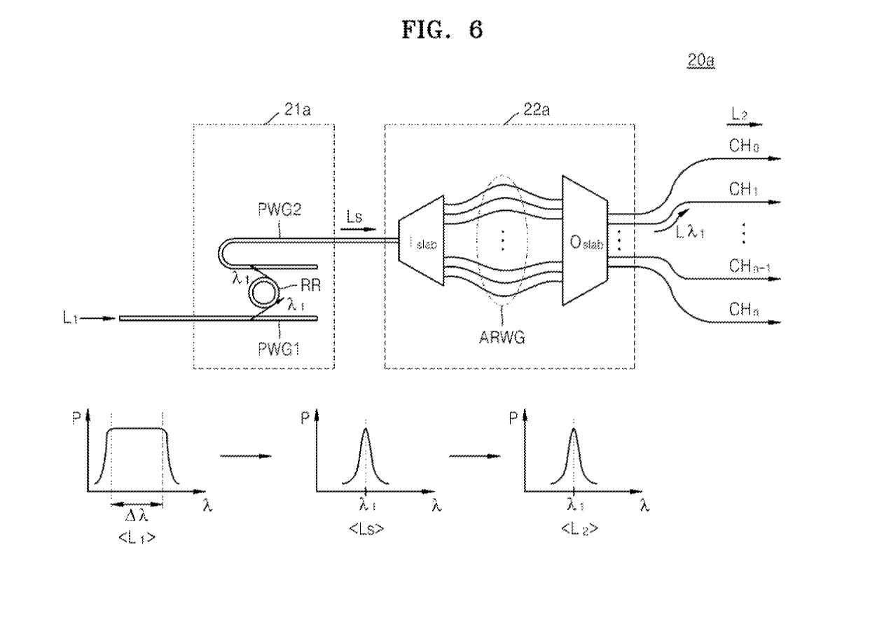

FIG. 6 is a view showing wavelengths of optical signals generated by the sensing block 20a of the optical biosensor 100a of FIG. 3. For convenience of description, a case where a resonant wavelength of the ring resonator RR is λ₁ will be described.

The first optical signal L1 is incident on the first optical waveguide PWG1 of the sensor 21a. The first optical signal L1 is an optical signal having a wavelength range Δλ. Since the resonant wavelength of the ring resonator RR is λ₁, a wavelength λ₁ is extracted from the wavelengths of the first optical signal L1 to be output as a sensing optical signal Ls through the second waveguide PWG2.

The sensing optical signal Ls is transmitted to the arrayed waveguide grating and is divided into wavelengths to be transmitted as the second optical signal L2. The second optical signal L2 is output for each wavelength through a corresponding channel of the channels CH0 to CHn. Here, since the sensing optical signal Ls includes only the wavelength λ₁, the second optical signal L2 also includes only the wavelength λ₁ and is output via the channel 1 CH 1 corresponding to the wavelength λ₁.

If the resonant wavelength of the ring resonator RR changes to λ₂ due to an increase in concentration of a biomaterial to be sensed, a wavelength of the second optical signal L2 is λ₂ and is output through the channel 2 CH2.

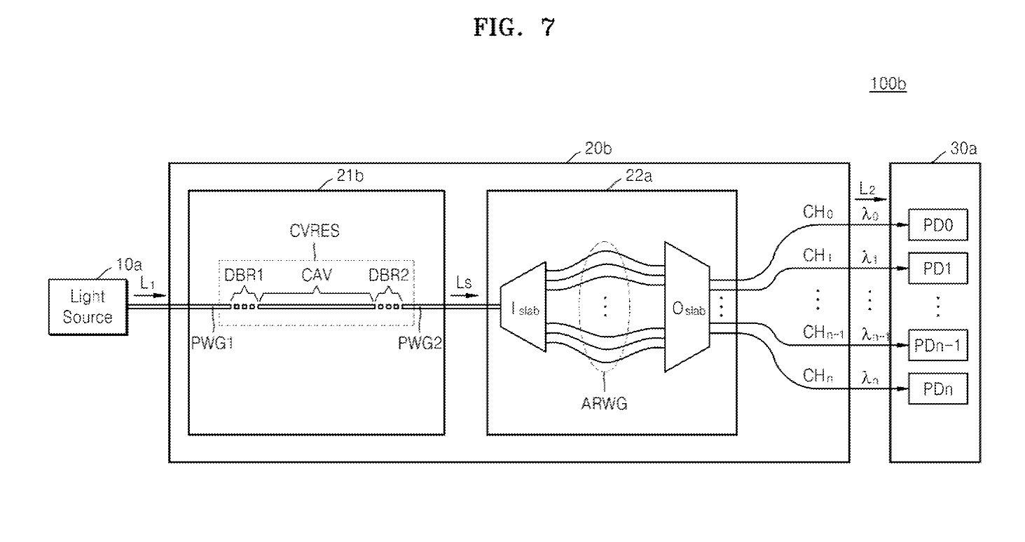

FIG. 7 is a circuit diagram showing an optical biosensor 100b according to another embodiment of the inventive concept.

Referring to FIG. 7, the optical biosensor 100b includes a light source 10a, a sensing block 20b, and a detecting block 30a. The light source 10a and the detecting block 30a of a current embodiment are the same as those of FIG. 3, and thus, a repeated description will be omitted.

The sensing block 20b includes a sensor 21b and a wavelength demultiplexer 22a. The wavelength demultiplexer 22a of a current embodiment is the same as that of FIG. 3, and thus, a repeated description will be omitted.

The sensor 21b generates a sensing optical signal Ls having a wavelength that varies according to a biomaterial concentration by receiving a first optical signal L1 and transmitting the sensing optical signal Ls to the wavelength demultiplexer 22a. The sensor 21b includes a first optical waveguide PWG1, a cavity resonator CVRES, and a second optical waveguide PWG2.

The first optical waveguide PWG1 receives the first optical signal L1 from the light source 10a. The cavity resonator CVRES outputs only a resonant wavelength from the wavelengths of the first optical signal L1 as the sensing optical signal Ls to the second optical waveguide PWG2. The second optical waveguide PWG2 transmits the sensing optical signal Ls to the wavelength demultiplexer 22a.

Referring to FIG. 7, the cavity resonator CVRES may include two distributed bragg reflectors DBR1 and DBR2 and a cavity CAV. The bragg reflectors DBR1 and DBR2 reflect a specific wavelength from a plurality of wavelengths of the first optical signal L1. Thus, the bragg reflectors DBR1 and DBR2 and the cavity CAV are coupled to each other to function as a resonator. Then, only a resonant wavelength that meets resonance conditions is generated and output as the sensing optical signal Ls.

An opening is formed in a top portion of the cavity CAV. A receptor for a biomaterial to be measured adheres to the top portion of the cavity CAV. If the receptor couples to the biomaterial, an effective refractive index of the cavity resonator CVRES may vary according to the strength of the coupling, that is, a concentration of the biomaterial. Thus, a resonant wavelength varies according to the concentration of the biomaterial, thereby changing wavelength components of the sensing optical signal Ls.

Comparing the optical biosensor 100b of FIG. 7 and the optical biosensor 100a of FIG. 3, there is a structural difference in the resonator included in the sensor 21b for generating the sensing optical signal Ls, and operations and signal characteristics of the sensor 21b, the light source 10, the wavelength demultiplexer 22a, and the detecting block 30 are the same.

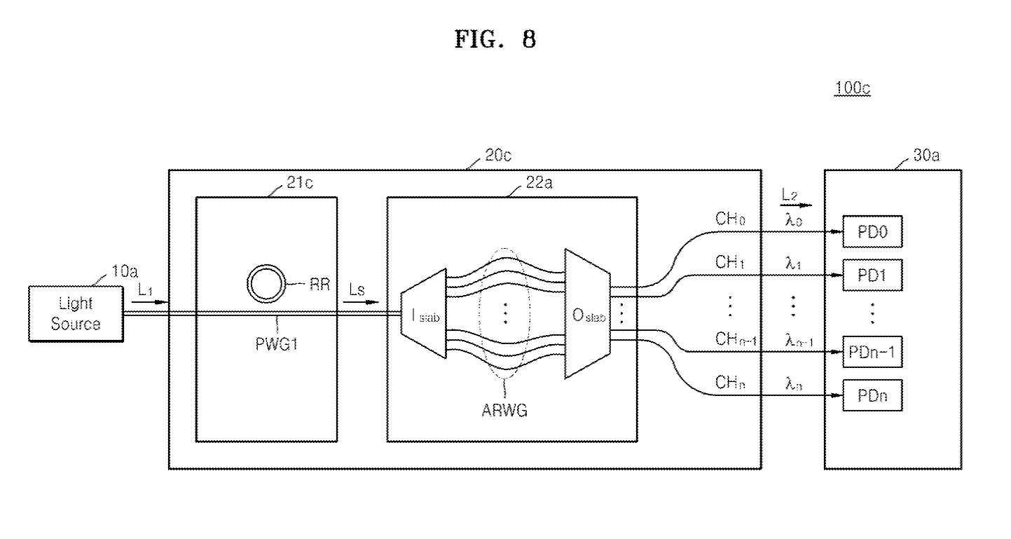

FIG. 8 is a circuit diagram showing an optical biosensor 100c according to another embodiment of the inventive concept.

Referring to FIG. 8, the optical biosensor 100c includes a light source 10a, a sensing block 20c, and a detecting block 30a. The light source 10a and the detecting block 30a of the current embodiment are the same as those of FIG. 3, and thus, a repeated description will be omitted.

The sensing block 20c includes a sensor 21c and a wavelength demultiplexer 22a. The sensor 21c includes a first optical waveguide PWG1 and a ring resonator RR. The first optical waveguide PWG1 and the ring resonator RR are separated by a predetermined interval. Although not shown in FIG. 8, an opening is formed in a top portion of the ring resonator RR similar to that shown in FIG. 4A. A receptor for a biomaterial of which a concentration is to be measured adheres to a surface of a core of the ring resonator RR. If the receptor couples to the biomaterial, a resonant wavelength of the ring resonator RR varies according to a strength of the coupling.

A first optical signal L1 incident on the first optical waveguide PWG1 from the light source 10a propagates along the first optical waveguide PWG1. A resonant wavelength from wavelengths of the first optical signal L1 that meets resonance conditions of the ring resonator RR is transmitted to the ring resonator RR. Thus, a sensing optical signal Ls from which the resonant wavelength has been removed may be generated and output through the first optical waveguide PWG1. Here, the resonant wavelength of the ring resonator RR varies according to a concentration of the biomaterial. Accordingly, a wavelength distribution of the sensing optical signal Ls varies according to the concentration of the biomaterial.

The wavelength demultiplexer 22a divides the sensing optical signal Ls according to wavelengths to generate and output a second optical signal L2 through a plurality of channels CH0 to CHn for transmitting different wavelengths. The second optical signal L2 includes a plurality of wavelengths, for example, wavelengths λ₀, λ₂, and λ₃, that may be respectively output through the channel 0 CH0, the channel 2 CH2, and the channel 3 CH3. The wavelength demultiplexer 22a of a current embodiment is the same as that of FIG. 3, and thus, a detailed description thereof will be omitted.

The photodetectors PD0 to PDn of the detecting block 30 convert the received optical signals into electrical signals. Since wavelengths included in the second optical signal L2 vary according to the concentration of the biomaterial, the electrical signals generated by the photodetectors PD0 to PDn may vary. Accordingly, the concentration of the biomaterial may be determined by analyzing an electrical signal generated by the detecting block 30.

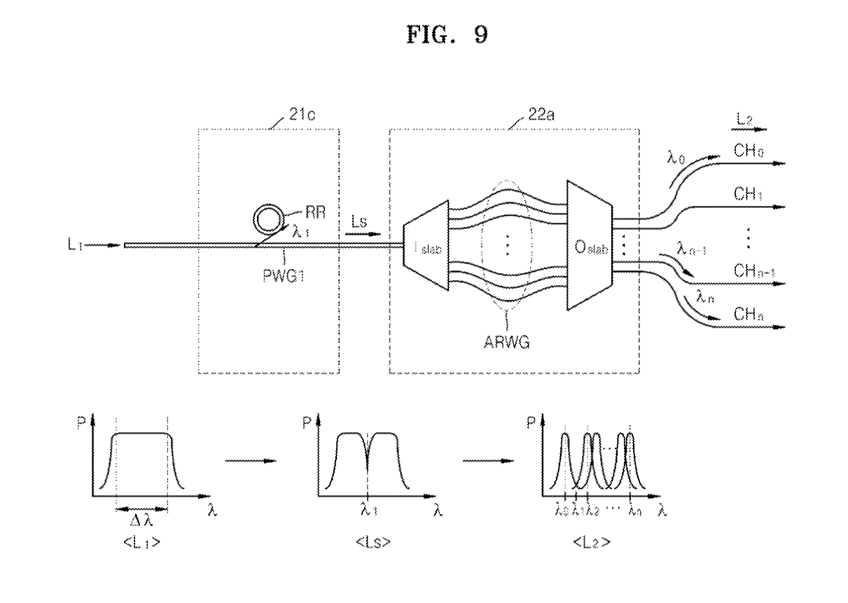

FIG. 9 is a view showing wavelengths of optical signals generated by the sensing block 20c of the optical biosensor 100c of FIG. 8. For convenience of description, it is assumed that a resonant wavelength of the ring resonator RR is λ₁.

The first optical signal L1 is incident on the first optical waveguide PWG1 of the sensor 21c. The first optical signal L1 is an optical signal having a wavelength range Δλ. When the first optical signal L1 propagates past the ring resonator RR, the resonant wavelength λ₁ is transmitted to the ring resonator RR through a gap and is removed from the first optical signal L1. An optical signal from which the resonant wavelength λ₁ has been removed from the wavelength range Δλ continues to propagate through the first waveguide PWG1 and is output as the sensing optical signal Ls.

The sensing optical signal Ls propagates to the wavelength demultiplexer 22a which divides the sensing optical signal Ls according to wavelengths to generate the second optical signal L2. The second optical signal L2 is output through the channels CH0 to CHn that correspond to the respective wavelengths. Since the wavelength λ₁ has been removed from the second optical signal L2, no optical signal having wavelength λ₁, or at most a weak optical signal of wavelength λ₁, is output through the channel1 CH1.

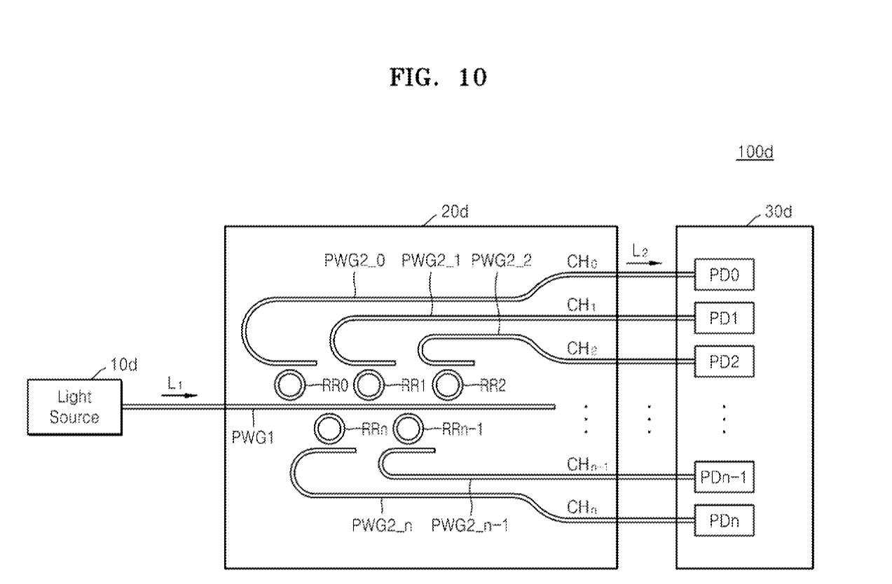

FIG. 10 is a circuit diagram showing an optical biosensor 100d according to another embodiment of the inventive concept. Referring to FIG. 10, the optical biosensor 100d may include a light source 10d, a sensing block 20d, and a detecting block 30d.

The light source 10d generates a first optical signal L1 including a single wavelength. The light source 10d may be an optical generating apparatus, for example, a laser diode, etc. However, embodiments of the inventive concept are not limited thereto, and the light source 10d may be an optical generating apparatus for generating a single wavelength, a circuit, etc.

The sensing block 20d may include a first optical waveguide PWG1, a plurality of ring resonators RR0 to RRn, and a plurality of second optical waveguides PWG2_1 to PWG2_n corresponding to the ring resonators RR0 to RRn. The ring resonators RR0 to RRn are disposed on two sides of the first optical waveguide PWG1 and are spaced apart by predetermined intervals. The second optical waveguide PWG2_1 to PWG2_n are disposed on two sides of the ring resonators RR0 to RRn and are spaced apart by predetermined intervals. This structure may be referred to as a ‘ring filter array’.

Resonant wavelengths of the ring resonators RR0 to RRn may differ from each other. Since the resonant wavelength may vary according to a concentration of a biomaterial, each ring resonator RR0 to RRn may be designed to resonate to a different resonant wavelength. When a first optical signal L1 having a single wavelength is incident on a first waveguide PWG1, the first optical signal L1 is transmitted to a ring resonator whose resonant wavelength matches the wavelength of the first optical signal L1. Then, the first optical signal L1 propagates to a corresponding second waveguide to be output as a second optical signal L2 via a specific channel.

Openings are formed in upper portions of the ring resonators RR0 to RRn as shown in FIG. 4A. Receptors for biomaterials to be measured may adhere to surfaces of cores of the ring resonators RR0 to RRn through the openings. Then, a fluid or gas including a biomaterial may contact the ring resonators RR0 to RRn through the openings. If the receptors couple to a biomaterial, effective refractive indexes of the ring resonators RR0 to RRn may change. Referring to EQ. (1), the resonant wavelength of the ring resonator is proportional to the effective refractive index. Thus, if the effective refractive index of the ring resonator changes, the resonant wavelength of the respective ring resonator may change. Therefore, the ring resonator that transmits the first optical signal L1 from the first waveguide PWG1 to a second waveguide may change, and consequently, a channel through which the first optical signal L1 is output may change.

The detecting block 30d includes a plurality of photodetectors PD0 to PDn corresponding to the respective channels, and each of the photodetectors PD0 to PDn detects an optical signal received through the respective channel, converts the optical signal into an electrical signal, and outputs the electrical signal. Thus, a concentration of a biomaterial may be determined by analyzing which photodetector has generated an electrical signal.

Hereinafter, the operation of the optical biosensor 100d of FIG. 10 for first optical signal L1 of wavelength λ₁ will be described. When an effective refractive index is n₀ and the resonant wavelengths of the ring resonators RR0 to RRn are respectively λ₀, λ₁, . . . λₙ before a biomaterial is applied, that is, when receptors adhere to outer portions of the ring resonators RR0 to RRn, if the effective refractive index of the ring resonators changes to n₁ because the biomaterial couples to the receptors, the resonant wavelengths of the ring resonators RR0 to RRn may change to λ1, λ2, . . . , and λn+1, respectively.

Since the wavelength of the first optical signal L1 is λ₁ before the biomaterial couples to the receptors, the first optical signal L1 propagates through the first optical waveguide PWG1 and is transmitted to the second resonator1 RR1 and the second waveguide PWG2_1 to be output as the second optical signal L2 via the channel1 CH1, and an electrical signal may be output from the photodetector 1 PD1 of the detecting block 30d. However, if the resonant wavelengths of the ring resonators have changed due to the coupling between the biomaterial and the receptor as described above, the first optical signal L1 is transmitted to the first ring resonator RR0 and the first waveguide PWG2_0 to be output as the second optical signal L2 via the channel 0 CH0. Accordingly, an electrical signal may be generated by the photodetector 0 PD0 of the detecting block 30d. Thus, a concentration of a biomaterial may be determined by analyzing which photodetector has generated an electrical signal.

FIG. 11 is a block diagram showing an optical biosensor 100′ according to another embodiment of the inventive concept.

Referring to FIG. 11, the optical biosensor 100′ may include a light source 10, a sensing block 20, a detecting block 30, and a signal processing unit 40. The light source 10, the sensing block 20, the detecting block 30, and the signal processing unit 40 may be formed on one semiconductor substrate, that is, may be integrated on-chip.

The optical biosensor 100′ further includes the signal processing unit 40, unlike the optical biosensor 100 of FIG. 1. The light source 10, the sensing block 20, and the detecting block 30 of a current embodiment are the same as those of FIG. 1, and thus, a repeated description will be omitted.

The signal processing unit 40 determines a concentration of a biomaterial by analyzing an electrical signal S_{elec} received from the detecting block 30. The signal processing unit 40 may store previously received electrical signals corresponding to concentrations of biomaterials as data and determine a concentration of a specific sensed biomaterial by analyzing the data. Alternatively, the signal processing unit 40 may determine a concentration of a biomaterial based on a characteristic of a resonator included in the sensing block 20, and on a variation of the electrical signal S_{elec} before and after the receptor couples to the biomaterial. In further alternative embodiments, the signal processing unit 40 may determine a concentration of a biomaterial from the electrical signal S_{elec} by using various other methods.

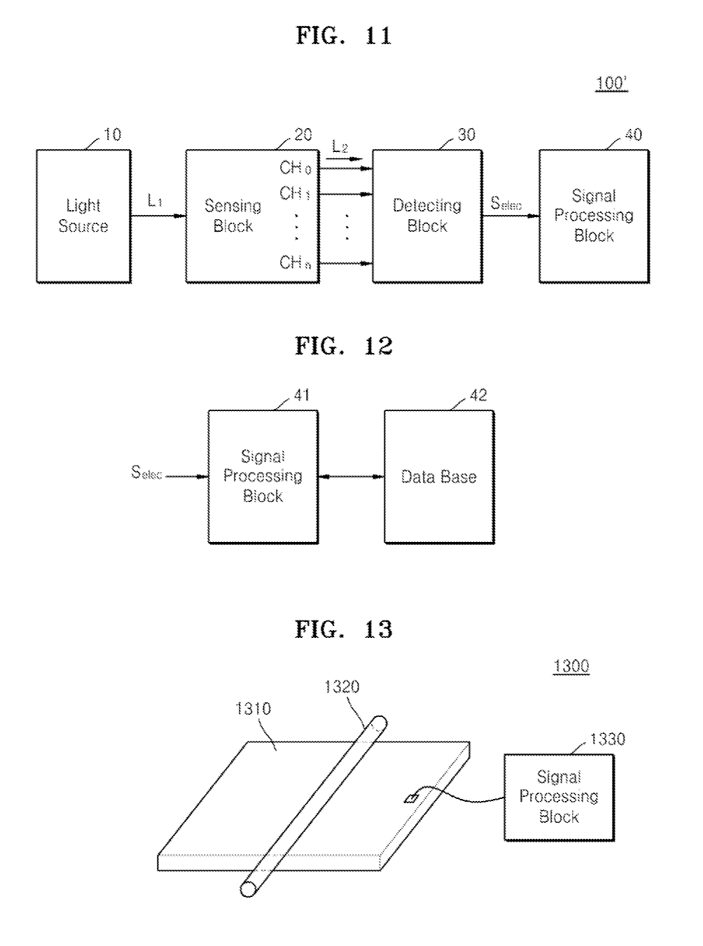

FIG. 12 is a block diagram showing an example of the signal processing unit 40 of FIG. 11.

Referring to FIG. 12, the signal processing unit 40 may include a signal processing circuit 41 and a database 42. The signal processing circuit 41 determines a concentration of a biomaterial based on a received electrical signal S_{elec}. The database 42 is may store data of the electrical signals S_{elec} that correspond to concentrations of biomaterials. The database 42 may store data regarding various biomaterials.

For example, if the electrical signal S_{elec} is received by the signal processing circuit 41, the signal processing circuit 41 may transmit information regarding a type of biomaterial and data of the electrical signal S_{elec} to the database 42, and may request a concentration of the biomaterial from the database 42. Alternatively, the signal processing circuit 41 may request data regarding a specific biomaterial from the database 42 and may determine a concentration of a biomaterial based on data received from the database 42 and data of the electrical signal S_{elec}.

FIG. 13 is a view of a bio-sensing system 1300 according to another embodiment of the inventive concept.

Referring to FIG. 13, the bio-sensing system 1300 may include a biosensor chip 1310, a fluidic channel 1320, and a signal processing unit 1330.

The biosensor chip 1310 senses a concentration of a biomaterial using optical characteristics and outputs the concentration of the biomaterial as an electrical signal. The biosensor chip 1310 included in the bio-sensing system 1300 of FIG. 13 may be an optical biosensor of FIG. 1. Since the biosensor chip 1310 generates an optical signal to sense a concentration of a biomaterial and outputs the sensing result as an electrical signal, an additional power source or a spectroscope, etc., are unnecessary. Accordingly, an optical biosensor is adapted for miniaturization, low power consumption, and portability.

The fluidic channel 1320 is a channel through which a biomaterial flows. The fluidic channel 1320 is arranged in a top portion of the biosensor chip 1310, in particular, in a portion where an opening of a sensor unit is located. If a fluid or gas including a biomaterial flows into the fluidic channel 1320, the biomaterial may contact the biosensor chip 1310 through the opening. The fluidic channel 1320 may be a micro fluidic channel, or a fluidic channel formed in a micro fluidic chip. Although the fluidic channel 1320 may have a linear shape as shown in FIG. 13, the fluidic channel 1320 may have various other shapes.

The signal processing unit 1330 determines a concentration of a biomaterial based on an electrical signal output from the biosensor chip 1310. The signal processing unit 1330 may be located in a conventional processing system, such as a computer, to receive the electrical signal output from the biosensor chip 1310 via a connection terminal and a connection line. Alternatively, the signal processing unit 1330 may be integrated with the biosensor chip 1310 and the fluidic channel 1320 into an individual biosensor system.

While embodiments of the inventive concept has been particularly shown and described with reference to exemplary embodiments thereof, it will be understood that various changes in form and details may be made therein without departing from the spirit and scope of the following claims.

What is claimed is:

1. An optical biosensor comprising:
a sensing block that receives a first optical signal and outputs through at least one channel of a plurality of channels a second optical signal that corresponds to a sensed concentration of a biomaterial; and
a detecting block that detects the second optical signal, converts the second optical signal into an electrical signal using a plurality of photodetectors, and outputs the electrical signal.

2. The optical biosensor of claim 1, wherein the optical biosensor further comprises a light source that provides the first optical signal to the sensing block, and a semiconductor substrate upon which the light source, the sensing block and the detecting block are disposed.

3. The optical biosensor of claim 1, wherein the detecting block comprises the plurality of photodetectors, each photodetector corresponding to one of the plurality of channels, wherein each photodetector converts the second optical signal received from the corresponding channel into the electrical signal.

4. The optical biosensor of claim 1, wherein the sensing block comprises:
a sensor that extracts from wavelength components of the first optical signal a resonant wavelength that corresponds to the sensed concentration of the biomaterial to generate a sensing optical signal; and
a wavelength demultiplexer that divides the sensing optical signal by wavelengths and outputs the divided sensing optical signal as the second optical signal.

5. The optical biosensor of claim 4, wherein the sensor comprises:
a first optical waveguide that receives the first optical signal from the light source;
a ring resonator separated from the first optical waveguide by a predetermined interval that extracts the resonant wavelength from the wavelengths of the first optical signal; and
a second optical waveguide separated from the ring resonator by a predetermined interval that receives the resonant wavelength from the ring resonator to transmit the resonant wavelength as the sensing optical signal.

6. The optical biosensor of claim 4, wherein the sensor comprises:
a first optical waveguide that receives the first optical signal from the light source;
a cavity resonator connected to the first optical waveguide that outputs a resonant wavelength removed from the wavelengths of the first optical signal as the sensing optical signal; and
a second optical waveguide connected to the cavity resonator that receives the sensing optical signal and transmits the sensing optical signal to the wavelength demultiplexer.

7. The optical biosensor of claim 4, wherein the wavelength demultiplexer comprises an arrayed waveguide grating.

8. The optical biosensor of claim 1, wherein the sensing block comprises:
a first optical waveguide that receives the first optical signal and outputs a sensing optical signal generated by removing from the first optical signal a resonant wavelength that corresponds to the sensed concentration of the biomaterial;
a ring resonator separated from the first optical waveguide by a predetermined interval that removes the resonant wavelength from wavelengths of the first optical signal; and
a wavelength demultiplexer that divides the sensing optical signal by wavelengths and outputs the divided sensing optical signal as the second optical signal.

9. The optical biosensor of claim 1, wherein the sensing block comprises:
a first optical waveguide that receives the first optical signal;
a plurality of ring resonators, each ring resonator being separated from the first optical waveguide by a predetermined interval and having a different resonant wavelength that varies according to a concentration of the biomaterial, wherein one of the plurality of ring resonators receives the first optical signal from the first optical waveguide when the resonant wavelength is the same as a wavelength of the first optical signal; and
a plurality of second optical waveguides respectively corresponding to the plurality of ring resonators, wherein each second optical waveguide is separated from the corresponding ring resonator by a predetermined interval.

10. The optical biosensor of claim 9, wherein a ring resonator receiving the first optical signal of a resonant wavelength from the first optical waveguide removes the resonant wavelength from the first optical signal and outputs the resonant wavelength as the second optical signal through the corresponding second optical waveguide.

11. The optical biosensor of claim 1, wherein the biomaterial comprises DNA or protein.

12. The optical biosensor of claim 1, wherein the optical biosensor further comprises a signal processing unit that determines a concentration of the biomaterial based on the electrical signal that is received from the detecting block.

13. A bio-sensing system comprising:
a fluidic channel through which a biomaterial flows; and
a biosensor chip having an opening that contacts the fluidic channel and that senses a concentration of the biomaterial flowing through the fluidic channel based on an optical characteristic and outputs the concentration of the biomaterial as an electrical signal,
wherein the biosensor chip has integrated onto one substrate a sensing block that senses a concentration of a biomaterial to output the concentration of the biomaterial as an optical signal, and a detecting block that converts the optical signal received from the sensing block into an electrical signal.

14. The bio-sensing system of claim 13, wherein the bio-sensing system further comprises:
a light source that provides light to the sensing block; and
a signal processing unit that determines the concentration of the biomaterial by analyzing the electrical signal.

15. An optical biosensor comprising:
a sensing block comprising one or more optical resonators, each of the one or more optical resonators adapted to removing a different resonant optical wavelength from a first optical signal comprising a plurality of wavelengths to generate a sensing optical signal, wherein said optical resonators are adapted for receiving and coupling to a biomaterial that changes the resonant optical wavelength of the resonator; and
a plurality of output channels, each output channel corresponding to a different resonant optical wavelength that corresponds to a sensed concentration of a biomaterial.

16. The optical biosensor of claim 15, further comprising:
one optical resonator;
a first waveguide that receives the first optical signal from a light source and provides the first optical signal to the one optical resonator, wherein the sensing optical signal generated by the one optical resonator comprises the resonant optical wavelength removed from the first optical signal;
a second waveguide that receives the sensing optical signal from the one optical resonator; and
a wavelength demultiplexer that receives the sensing optical signal from the second waveguide, divides the sensing optical signal by wavelengths, and outputs the divided sensing optical signal as a second optical signal to each of the plurality of channels.

17. The optical biosensor of claim 16, wherein the optical resonator is one of a ring resonator or a cavity resonator.

18. The optical biosensor of claim 15, further comprising:
one optical resonator;
a first waveguide separated from the one optical resonator by a predetermined distance that receives the first optical signal from a light source, wherein the sensing optical signal generated from the first optical signal by the one optical resonator does not include a wavelength component corresponding to the resonant optical wavelength; and
a wavelength demultiplexer that receives the sensing optical signal from the first waveguide, divides the sensing optical signal by wavelengths and outputs the divided sensing optical signal as a second optical signal to each of the plurality of channels.

19. The optical biosensor of claim 15, further comprising:
a plurality of optical resonators;
a first waveguide separated from each of the plurality of optical resonators by a predetermined distance that receives the first optical signal from a light source, wherein one of the plurality of optical resonators receives the first optical signal from the first optical waveguide when the resonant wavelength is the same as a wavelength of the first optical signal, removes the resonant wavelength from the first optical signal and outputs the resonant wavelength as a second optical signal; and
a plurality of second optical waveguides that respectively correspond to the plurality of optical resonators, wherein each second optical waveguide receives the second optical signal from the corresponding optical resonator and outputs the second optical signal to a corresponding channel of the plurality of channels.

20. The optical biosensor of claim 15, further comprising a detecting block that includes a plurality of photodetectors, each photodetector connected to one of the plurality of output channels, wherein each photodetector is adapted to detecting an optical signal received through the corresponding output channel, converting the optical signal into an electrical signal, and outputting the electrical signal.
